(19) United States
(12) Patent Application Publication
(10) Pub. No.: US 2016/0055760 A1
(43) Pub. Date: Feb. 25, 2016

(54) SYSTEM AND METHOD FOR GENERATING HEALTH & LIFESTYLE OBSERVATIONS AND RECOMMENDATIONS FOR AN INDIVIDUAL

(71) Applicant: Christopher Mirabile, New York, NY (US)

(72) Inventor: Christopher Mirabile, New York, NY (US)

(73) Assignee: Christopher Mirabile, New York, NY (US)

(21) Appl. No.: 14/671,488

(22) Filed: Mar. 27, 2015

Related U.S. Application Data
(60) Provisional application No. 61/972,197, filed on Mar. 28, 2014.

(51) Int. Cl. G09B 19/00; G09B 5/06; G06F 19/00

(52) U.S. Cl. CPC G09B 19/00; G06F 19/363; G09B 5/06

(57) ABSTRACT

A system and method is disclosed for generating health and lifestyle related observations and recommendations for a user, based on information collected from the user. The system and method of the present invention is configured to accept user inputs that include activity, physical, biological, environmental, subjective, goal, real-time and historical user information, inputted directly into the system, or via a third party integration. Invention references aggregated information across users and from additional sources, and generates relevant recommendations and observations, based on the system's computational methods applied to the user's inputs. The system and method considers the user's goals and system default goals in the generation of recommendations. The system and method allows for the data and generated observations and recommendations to be outputted within the system's user experience, or to a third party.

### CROSS-REFERENCE TO RELATED APPLICATIONS

The present application is related to and claims the benefit of the earliest effective filing date(s) from the following listed application (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

### RELATED APPLICATIONS

For purposes of the USPTO extra-statutory requirements, the present application constitutes a continuation-in-part of U.S. patent application No. 61/972,197, entitled SYSTEM AND METHOD FOR GENERATING HEALTH & WELLNESS OBSERVATIONS AND RECOMMENDATIONS FOR AN INDIVIDUAL, naming Christopher Mirabile as investors, filed 27 Mar. 2014, which is an application of which this application is entitled to the benefit of the filing date.

### FIELD

The present invention relates generally to electrical and electronic hardware, computer software, wired and wireless network communications, and computing devices. More specifically, general health and wellness management methods and devices.

### BACKGROUND

Today we find ourselves in a health and wellness environment unlike any other in history. With the advent of advanced technologies that are capable of decoding one's genome for a nominal fee, blood tests that can instantly detect numerous biomarkers from a drop of blood, and wearable or biologically integrated devices that can seamlessly track innumerable data points directly from an individual, we are witnessing the medical laboratory rapidly moving to the consumer, much like mainframe computers became accessible in the form of Personal Computers.

With the proliferation of these affordable, convenient technologies, interest in a movement known as Quantified Self has rapidly grown. Evangelists of the lifestyle tend to focus on quantifying and logging as many data points about themselves as possible, with the hopes of better understanding themselves, by observing patterns, tracking correlations, attempting to identify causal relationships, and more. One may argue that Quantified Self is rapidly extending beyond the passionate early adopter and into the masses, when one considers the advent of consumer friendly smartphone applications, wearable wristbands and watches that track steps taken, distance traveled, calories burned, heart rate, body temperature, sleep duration, and more.

With a growing number of devices tracking innumerable data points, we're on the brink of yet another explosion in Big Data. Cloud computing solutions already provide individuals and applications with constant, global access to software and databases. Yet, at present, most of this data fails to be utilized beyond a small fraction of its potential, as most people and current software offerings have trouble analyzing, interpreting, and leveraging it to form actionable insights or new knowledge, particularly when more than one variable is involved.

There is a gap in the marketplace, where individuals are not equipped with the knowledge, insights or experience needed to fully comprehend the implications of their activity, lifestyle and/or health data beyond face value, understand how factors may impact one another, nor how to make more informed decisions, in agreement with their intentions and goals. Further, as additional data is introduced, these complexities grow.

We are simultaneously witnessing the most rapid growth rate of scientific and medical knowledge in human history, yet knowledge transfer to the public is inefficient at best. This is due to many factors, including that more knowledge is produced than a human is capable of absorbing, the complexities and inabilities for non-specialists to comprehend the information, the lack of relevancy or intellectual interest to the individual, the requirement to examine the discovery in context of other knowledge, a lack of a mechanism to transfer the knowledge in a simple fashion, among others. It would be advantageous to individuals and society if people were equipped with a system that could apply well-vetted scientific and health knowledge in a user-friendly, comprehensible and personally relevant manner. This would afford individuals with the ability to better comprehend their health and wellness data, and understand the cause and effect that actual and hypothetical decisions can have on their health and derivatives of their health.

A look at the health situation in the world's most wealthy nations—such as the United States and Great Britain—underscores the value of such a system. Despite the exponential growth in health and wellness knowledge, data and devices, wealthy nations that have greater access to these assets than any other, are suffering from the highest levels of avoidable illnesses ever known. These illnesses include cardiovascular disease, diabetes, obesity, gastrointestinal disorders, autoimmune disorders, depression and certain forms of cancer. To date, the focus of Western medicine has been to cope with these and other maladies, rather than to emphasize the study and importance of preventative measures. This lack of focus on prevention has been a major contributor to the rapid inflation in healthcare costs.

The purpose of this System is to connect the dots between the emerging health, medical and self-tracking technologies; the low friction benefits of the Quantified Self movement; insights gleaned from big data, combined with medical and scientific research; and humanity's innate desire to survive and thrive, in order to cope with and avoid maladies, improve health and vitality and achieve one's health and wellness related goals. The System starts by analyzing a user's data to derive insights unique to the individual, then leverages research and/or big data to further refine Observations, Recommendations, actionable Steps and new knowledge discovery. The potential societal implications of this invention include a reduced strain on the medical establishment, more rapid scientific hypotheses and discoveries, and overall decreased pain and suffering.

### BRIEF SUMMARY OF THE INVENTION

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate gathering data about and/or from an individual (“end-user”, or “user”) or group of individuals (“end-users”, or “users”) in order to provide one or more recommended actions (“recommendation(s)”) for arriving at a particular outcome for the individual user (“outcome”, or “goal”). The system may also generate noteworthy observations (“observation”) about each user of the system, in order to assist in the accurate formulation of recommendations, and in certain cases, to generate user-specific goal suggestions and help the user to better comprehend the health, wellness and lifestyle implications of their data. The innovation can collect and aggregate statistics or data from an individual user, other users of the system, an entire population, independent research studies, as well as potentially relevant data that is actual and factual, from any other sources that may conceivably have an impact on an individual(s)'s attainment of a goal, even if not yet proven (e.g., historical weather information).

The collected information can be sourced directly from the individual, from a verified professional, system administrator or any other trusted third party source, and may be inputted on an individual or aggregate basis via an interface. End-users and other sources of data may connect to the interface via the internet or a secure network. For example, an individual may be wearing a WiFi-enabled biometric watch, which gathers basic information about the user in one-second intervals (e.g., heart rate, blood pressure, blood oxygen saturation levels, movement, skin perspiration, etc.), and transmits the collected data to the system via an SSL-encrypted connection. In another example, a medical laboratory may provide the system with an individual user's blood test results (e.g., HbA1c, Total Testosterone, Free Testosterone, SHBG, etc.), via a secure web-based graphical user interface that connects directly to the system's interface. In yet another example, the blood test results of an entire population, complete with demographic information, may be added to the system's data store of aggregate information via a verified, encrypted batch upload process. A trusted source is to be determined by system operators, but is generally one that provides accurate, reliable, factual information.

Data provided to the system is collected and saved to a data store, in accordance with User and system privacy, security and data treatment settings and preferences. Stored data is made available for the system to analyze.

The data analysis module is capable of preparing the data for the generation of efficient and accurate observations and recommendations. Data preparation may include normalizing data, generating semantic data stores, associating metadata, generating new data based on definitive or extremely likely assumptions, and more.

Observations of a user's data are made in relation to itself and/or aggregated data sets, and include statistical outliers, trends, correlations, prognoses, diagnoses, and other findings made possible through statistical, artificial intelligence and data mining methods. Observations are based on a user's data, and generally relate directly or as derivatives of the user's health, wellness and lifestyle.

Desired outcomes, or goals, are selected by or on behalf of a user by a trusted third party, or by the system, which may be based on system default desired outcomes (for example, survival, avoidance of pain, etc., also referred to as “universal truths”), user-inputted system preferences, observations about the user, among others.

Recommendations are generated for the user based on the combination of desired outcomes and user data; recommendations can be further improved and new recommendations generated with the addition of aggregate data. The system is capable of analyzing the user's data, including the user's current state and historical information, in determining whether a goal is feasible and safe, and if it is, generates recommendations for its achievement. The system may generate innumerable recommendations for achieving the goal, and will rank the recommendations by system-derived factors that may include likelihood for success, predicted or explicit user preferences, system preferences, etc. Recommendations are also dynamic, in that they are capable of being adjusted and updated as the system acquires any type of new data.

All or portions of raw data, prepared data, recommendations, goals and when available, observations, may be outputted via the system's output module. The output module can produce data, images, video, sound, motion, physical output, device instructions, etc., via interfaces that include application programming interface (API), graphical user interface (GUI) and command-line interfaces. Outputted information can be provided to the User or a trusted third party such as a caretaker, guardian or doctor, via one or multiple devices.

The following description and the annexed drawings set forth detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates aggregating health and lifestyle data from individuals and organizing it in order to be able to make recommendations for achieving specific outcomes.

FIG. 2 illustrates a block diagram of an exemplary system that facilitates aggregating health, lifestyle and environment data from individuals and other resources, and organizing it in order to be able to make recommendations for achieving specific outcomes.

FIG. 3 illustrates a block diagram of an exemplary system that facilitates combining multiple forms of data across individuals' devices and having the data stored and analyzed within a cloud environment.

FIG. 4 illustrates a block diagram of an exemplary system that facilitates the verification of collected data, in order to ensure the accuracy of the system.

FIG. 5 illustrates a block diagram of an exemplary system that facilitates the distinct treatment of user data, based on user preferences and settings.

FIG. 6 illustrates a block diagram of an exemplary system that facilitates the generation of new user data based on its analysis relative to aggregate data.

FIG. 7. illustrates a block diagram of an exemplary system that facilitates the generation of recommendations and observations for a user.

FIG. 8 illustrates a block diagram of an exemplary system that facilitates the determination of desired outcomes and the resulting recommendations.

FIG. 9 illustrates a block diagram of an exemplary system that facilitates the system's ability to make requests for specific information, in order to generate additional recommendations or observations.

FIG. 10 illustrates a block diagram of an exemplary system that facilitates the filtering and prioritized sorting of system-generated recommendations.

FIG. 11 illustrates a block diagram of an exemplary system that facilitates the system incorporating an output component.

FIG. 12 illustrates a block diagram of an exemplary system that facilitates the collection and output of information via the same or connected interface.

### DETAILED DESCRIPTION

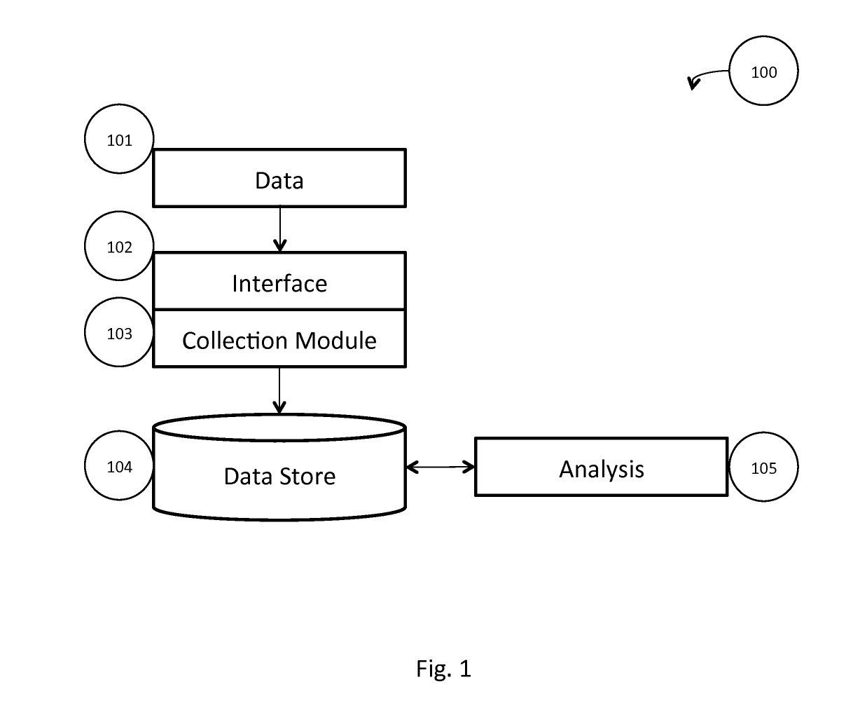

FIG. 1 illustrates a system 100 that includes an interface module 102 that is capable of collecting 103 information 101 from or on behalf of an individual user of the system (“end-user”), system administrator and/or aggregate information from a given population. This information is saved to data storage 104, where the system can analyze 105 the data for improved organization and to generate recommendations.

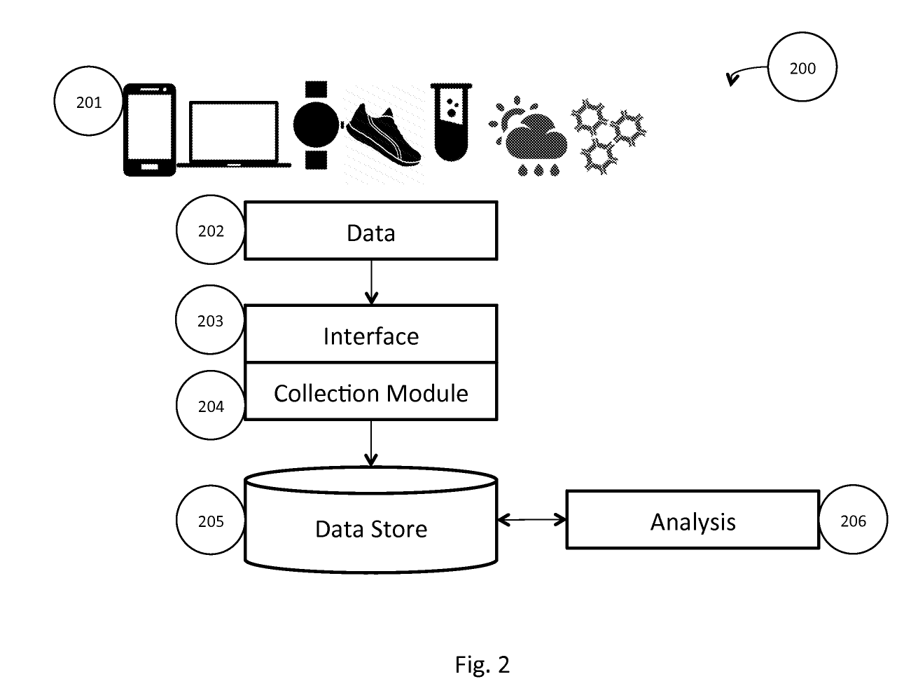

FIG. 2 illustrates a system 200 where the collected information 202 can come from one or a combination of multiple sources and devices 201, including a user's manual input, user's dynamic data, including sensor-based data, research study data, aggregate population or user data, general data (e.g., weather), etc.

The data can be collected via a variety of means 201, including any one or combination of a computer or laptop; smartphone; wearable device; biologically integrated device and data feeds from third-party applications, devices and data sources 3. Each device connects to the system's collection module 204 via an interface 203. Interfaces can vary from application programming interface (API), command-line interface (CLI), graphical user interface (GUI), among others.

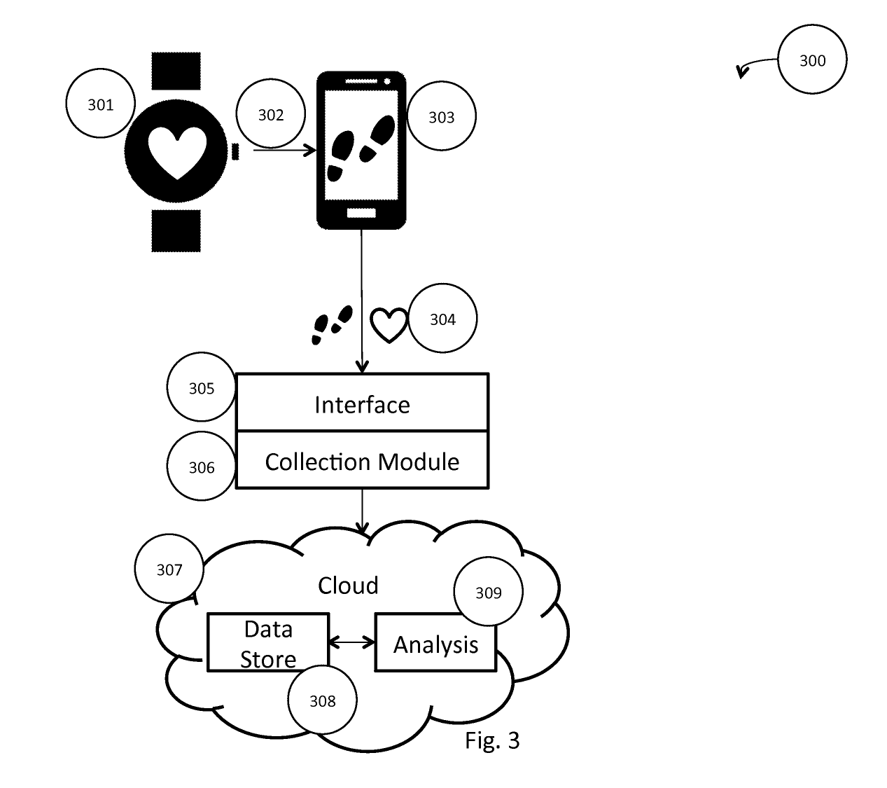

FIG. 3 illustrates a system 300 where each device may be intended for collecting, saving, sharing or analyzing data, or any combination thereof. For example, a user may wear a watch 301 that integrates GPS, heart rate and galvanic skin sensors. This watch may collect and save the user's data, then share it 302 via a Bluetooth connection with the user's smartphone 303 at specific time intervals. The smartphone combines its footstep data with the watch's data 304, connects to the system's interface 305, where the collection module 306 organizes and saves the combined data to the system's cloud 307 data store 308, where it is analyzed 309.

The types of information collected can include objective, subjective, qualitative, and quantitative information; inferences; universal truths (system default desired outcomes); processes; raw data; processed data; audio; visual; temperature; multi-dimensional movement; etc. Inferences may include established scientific findings, causal relationships, non-causal correlations, etc. Typically, universal truths are generally accepted facts about living animals, such as the desire to survive and the desire to avoid pain. Processes may include the currently established, definitive procedures, methods and/or steps for achieving a given outcome. For example, specific blood test(s) to be employed for the detection of a given virus. The system may also collect user-specific preferences and settings that relate to privacy, security, data collection and treatment, device variables, and rules or logic to be applied to data analysis, observations and recommendations. Additionally, the system may collect general or specific goals (desired outcomes) from a user. Raw data, i.e., data that has not be manipulated, altered or cleaned (i.e., the removal or certain information) in any way, will be marked as such when saved to the database.

The following forms of information are for illustrative purposes and are not intended to be an exhaustive list of all viable factors, nor a list of factors that the system requires for analysis in the generation of observations, goals and recommendations. Any single factor, combination of factors or other factor(s) that are not included in this list may be used by the system. Additionally, a factor may only apply to individual user data, aggregate user data, aggregate research data, or any combination thereof.

For the case of the system being employed for a human, data that can be indicators of or influences on one's health, lifestyle and outcomes related to such, are collected from an individual user, aggregate users, or research studies. This data may be collected via a variety of means, technologies and interfaces, including information related to physical attributes, (e.g., sex, age, height, weight, body mass index [“BMI”], body fat percentage, body measurements [e.g., waist, bust, arm, chest, etc.], etc.); date of birth; sex; race or ethnicities; personality (e.g., Myers-Briggs Type Indicator, etc.); mood and psychological state survey results; medical history and current medical conditions and ailments (e.g., type I and type II diabetes, cancer [including type(s) and status], ADHD, depression, anhedonia, obesity, heart disease, physical injury, libido, allergies, flu, infertility, adrenal fatigue, etc.); blood levels, including cardiovascular markers (e.g., total cholesterol, LDL cholesterol, HDL cholesterol, triglycerides, ApoA1, ApoB, LP(a), Lp-PLA2, Omega-3 Fatty Acids, Free Fatty Acids, etc.), liver & kidney health (e.g., BUN/Creatinine, AST & ALT, Total Bilirubin, Albumin, Total Protein, etc.), performance hormones (e.g., DHEA, Free Testosterone, Testosterone, Estradiol, SHBG, etc.), metabolic hormones, (e.g., cortisol, IGF-1, insulin), blood sugar (e.g., fasting and postprandial blood glucose, HbA1c, etc.), blood ketones, advanced thyroid (e.g., Total T4, T3 uptake, free T4 index, TSH, total T3, free T3, reverse T3, free T4, etc.), advanced Inflammation (e.g., hs-CRP, fibrinogen, homocysteine, etc.), blood count and advanced nutrients (e.g., complete blood count with differential, calcium, electrolytes, bicarbonate, ferritin [serum], total Iron binding capacity [TIBC], folate, vitamin B12, RBC Magnesium, 25-Hydroxy vitamin D, etc.), womens' reproductive panel (e.g., progesterone, FSH, Luteinizing Hormone, etc.); blood pressure (diastolic, systolic); food allergens; food sensitivities; hormone levels (via blood, urine and/or saliva tests); assessment of physical/athletic health (i.e., recent physical activity, upload of heart rate/activity information, etc.); resting heart rate; active heart rate and heart rate variability during specific activities (i.e., while working, while walking “x” mph for “y” minutes, etc.); VO2 max; body temperature; genetic testing—DNA sequencing; neural waves (e.g., EEG, HEG and other readings); hormonal cycles; sleep effectiveness (raw sleep data, including EEG, heart rate, breath and movement results, or summarized data, including sleep onset, total time, time per sleep stage, pattern of sleep, apneas, hypopneas, arousals, etc.); data relevant to an activity (heart rate, skin temperature, horizontal and vertical distance, duration, weight of self and equipment, repetitions, etc.); radiology results (x-ray, CT, PET, ultrasound, MRI, fMRI, etc.); activities (type, duration, time, intensity, power, etc.); occupation; family medical history; historical eating patterns; historical food intake and meal ingredients (including quantity); subjective feedback about meal history (post meal physical and psychological reactions); air levels (CO2, O2, O3, CO3, etc.); exposure to weather; exposure to toxins (mold, spores, germs, viruses, etc.); performance on objective or subjective tests; receipt of physical therapy (massage, acupuncture, yoga, etc.); receipt of electrical or magnetic stimulation (CES, tDCS, TMS, etc.); social activity (in-person, virtual [online, telephone, etc.], and in what form, with whom, where, when, etc.); community service and philanthropic efforts; expression of gratitude; stress levels (subjective or physiological [hormones, blood pressure, heart rate variability, etc.]); engaging in leisurely activity (type, duration, location, etc.); spiritual activity (prayer, meditation, etc.); consumption of content (watching television, browsing the internet, reading a book, etc.); production of content or information and when appropriate and available, the information saved to the system for analysis (writing, publishing to social media, email and text messages, vocal conversations, creating art, playing an instrument, etc.); posture; drug and supplement intake (illicit, prescription, over-the-counter, homeopathic, etc.); objective performance on a test, game or challenge (e.g., performance on a memory test, “Dual N-Back”, IQ test, mood assessment, video game reaction time, etc.); living & work conditions; geocodes; size of home and/or workplace; time spent outdoors; time spent with natural sunlight; lighting conditions (e.g., light type, color, power, time, etc.); occupation; time spent sitting vs. standing; time spent watching television or in front of a computer; scientific or research study methodology; and other related relevant information, including those that are currently cost prohibitive or have not yet been measurable or discovered, but will be in the future.

User information or data can also include desired outcomes, or goals, which are states or markers of health, wellness, lifestyle and/or achievements directly impacted by such factors, that a user wishes to attain, such as physical (weight loss, weight gain, muscle gain, increased flexibility, etc.); medical (such as the reduction of odds for acute or chronic illnesses or maladies, e.g., prevent the onset of Type II diabetes, prevent various forms of cancer, prevent cardiovascular disease, reduce the occurrence of gastrointestinal issues, etc.), or coping with acute or chronic illnesses, maladies or addictions/dependencies (minimize the risks or side effects of diabetes, heart disease, cancer, flu, obesity, heat exhaustion, musculoskeletal impediments, mental or physical fatigue, alcoholism, etc.); altering mood or emotional state (reduce depression and anhedonia, increase happiness, increase contentment, increase mental vitality, etc.); increasing mental capacities (improve focus, concentration, working memory, long-term memory, attention span, comprehension, IQ, etc.); activity, including athletic achievement (complete a marathon, bicycle one mile within a given timeframe, bench press a target weight, etc.); increasing longevity; improving lifestyle (improve sleep efficiency, sleep onset, sleep duration, stress response, breathing, environment to be more conducive to optimal health, etc.); achievement of an experience (lucid dreaming), performance on a specific task (sexual performance, exam, etc.), etc.

User information can also include preferences and settings, which enable the user to adjust how the system treats their data, including its privacy; system preferences for how goals, recommendations and/or observations are treated, including their presentation, prioritization, etc.; device and third party application integrations and settings; security; selection of trusted third parties; output and presentation; etc.

When possible, the system's data store saves the time stamp associated with each individual piece of data that is collected, as well as the time when the data was submitted to the system. For example, each footstep that a user takes is time stamped by the device taking the measurement, and each submission of data to the system is time stamped (which may be in the form of a batch upload of combined footstep information); the system saves both time stamps, for use during data analysis (including observations and recommendations), output and visualization modules.

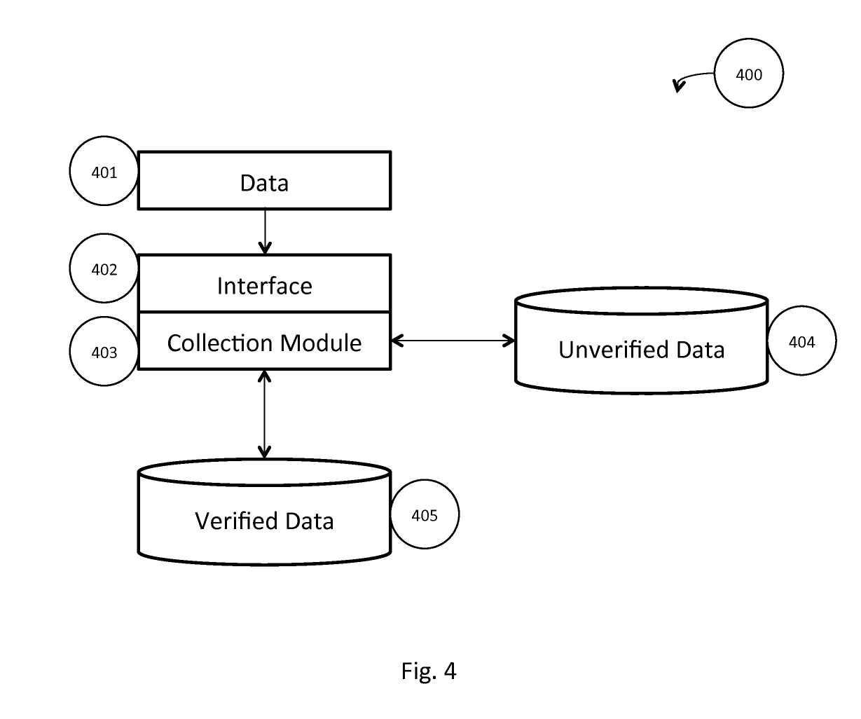

FIG. 4 illustrates a system that, as part of the system's Collection module, authenticates and verifies incoming information 400. Incoming data 401 is connected to the system via the interface 402, where the collection module 403 attempts to verify the authenticity and quality of the data. Unverified data 404 is contained in a separate data store, until it is able to be verified. Verified data is contained in its own verified data store 405 for system analysis.

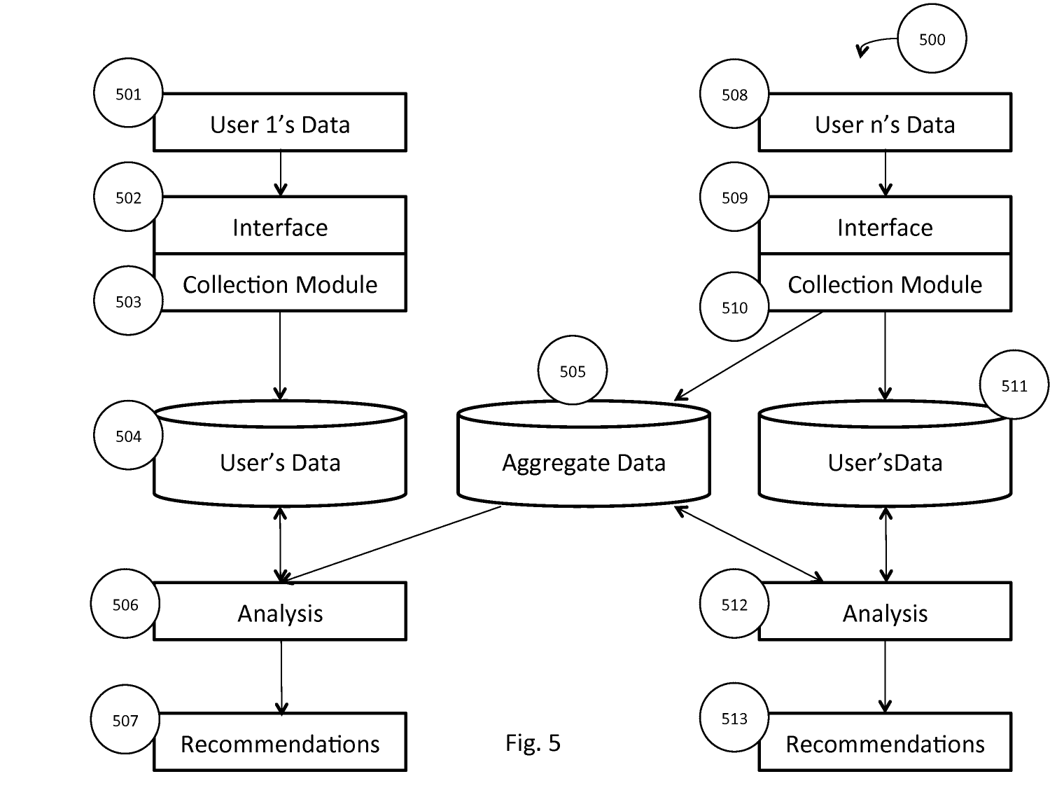

FIG. 5 illustrates a system where system-wide and user-specific security and privacy preferences are applied to the data, to ensure its proper handling 500. For example, in one embodiment, a User 1 elects to keep their data private and it is therefore not combined with aggregate user data. Rather, User 1's data 501 is collected 503 via the system's interface 502, saved to a separate data store 504, and analyzed 506 in relation to itself and the aggregate data 505; recommendations are generated 507. User n elects to anonymously share their data with the community. User n's data 508 is collected 510 via the system's interface, where it is saved to an aggregate data store 505 and the user's data store 511. The system analyzes 512 the users data to itself and to aggregate data 505, and generates recommendations 513.

Collected data is stored in one or multiple forms of memory. For example, the data store can be composed of volatile memory, non volatile memory or both. The data store 104 can be composed of one or any combination of a server, a database, external hard drive, portable hard drive, the cloud, a health tracking device's storage, and the like.

Data is collected in the raw and is unadulterated. For any cases where this may not be the case, the system will mark the data as such, for the system's logic and/or a system administrator to determine how the data should be treated.

Any required or ideal interface components to connect data sets, databases, and modules (including, collection, storage, device interfaces, analysis, output, etc.) to one another are included in this invention.

The system will analyze collected data in order to prepare it for further analysis (data preparation), generate recommendations, and optionally, to generate goals and observations.

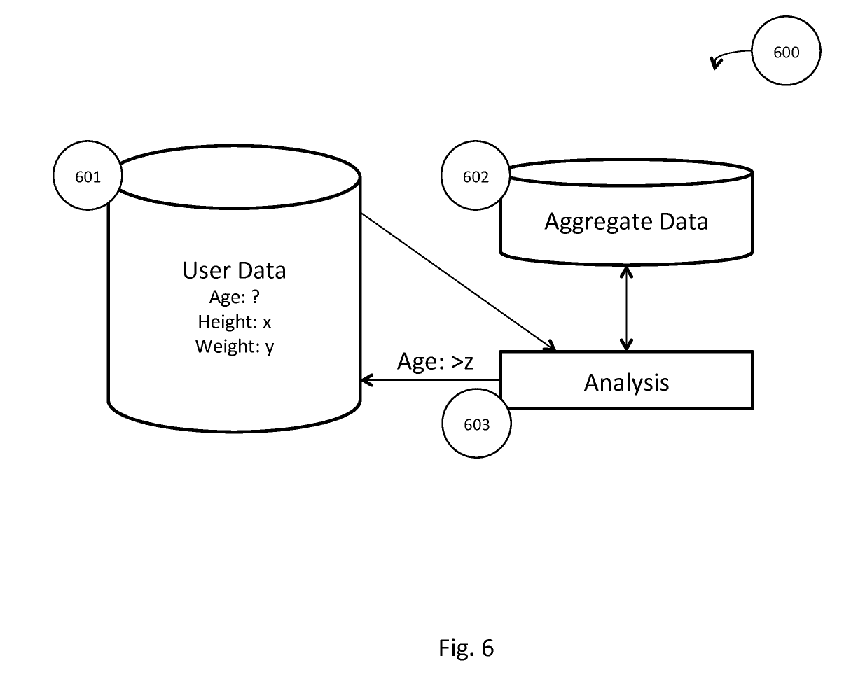

FIG. 6 illustrates a system where when the system has adequate information, it may generate new data based on highly likely assumptions about the user 600. For example, based on a user's inputted height and weight 601, the system may determine based on the analysis aggregate data 602, and to a very high degree, or absolute certainty, that the user is equal to or greater than eighteen years of age 603.

The system may also associate separate datasets with the user's data, when relevant and certain. For example, if the system knows the user's GPS coordinates, additional data can be associated with the user, including weather, time zone, venue and venue categories (for example, at home, work, a bar, a concert hall, entertainment and social categories, etc.).

Multiple forms of data may be combined together to form metadata. For example, the combination of GPS, galvanic skin readings, heart rate and three dimensional movement data suggests that a user was running during a given time increment.

In addition to relation databases and object-oriented databases, the system may be based on or generate semantic data stores, which is an abstraction that defines how the stored information relates to the real world.

The system may analyze qualitative and/or subjective information, in order to produce quantitative values. For example, tone of voice from an audio recording, or semantics from a text message, may be analyzed in order to assign a numerical value indicating a user's mood.

The system will also consider the reliability and/or accuracy of the data. For example, body fat measuring technologies, such as body fat calipers, DEXA scans and BodPod scans, all have varying levels of accuracy, which can fluctuate based on the sample's body fat percentage, gender, individual who is administering the test, etc. The degree to which these factors can vary can be indicated in the system's logic or added directly to the data, for consideration in future analysis.

The system will also normalize or standardize data, when appropriate. For example, if raw footstep data is unavailable and it is known that one distance tracking wearable device equates one mile to be equal to 1,500 footsteps, and the other equates it to be equal to 1,475 footsteps, the system may normalize the footsteps to one reference value.

Certain data may also apply for an extended period of time or to multiple time periods, beyond what the raw data without analysis would indicate. For example, the mood recorded from a journal entry may apply to how the user has felt over the course of the previous 24 hours, e.g., “I've been so happy for the past day!” The system may analyze the text to arrive at this time interval, and then apply the recorded mood to this time period.

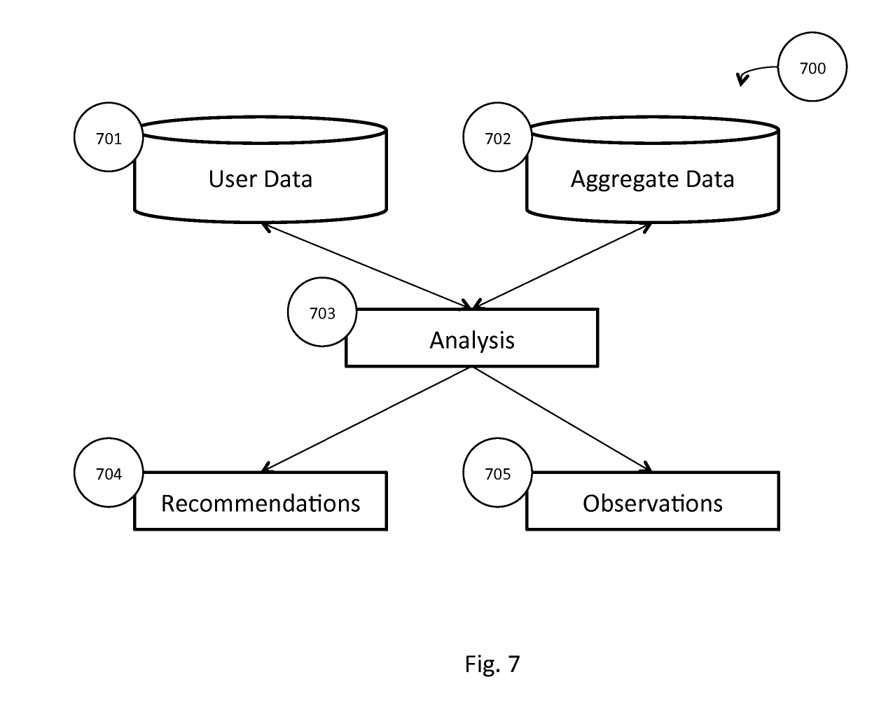

FIG. 7 illustrates a system where analysis can generate observations, in addition to recommendations 700. User data 701 and/or aggregate data 702 is analyzed 703, and both recommendations 704 and observations 705 are generated. These observations can be based on an analysis of the user's data to itself, to aggregate data, or any combination thereof. Observations may include identification of outliers, general trends and correlations, user-specific trends and correlations, noteworthy facts, prognoses and diagnoses.

For example the system may observe outliers within a user's data and exclusive of aggregate data, such as that today was their least physically active day since using the system. Or, the system may observe outliers within a user's data, inclusive of aggregate data, such as that their body fat percentage is 5% above the maximum level considered to be safe, or, that their weekly running distance is in the top 1% of all users of the system.

User-specific trends and correlations may be identified, based on the analysis of a user's data in relation to itself and exclusive of aggregate data. For example, the system may identify a statistically significant trend, where the user's mood is progressively worsening. In one embodiment, the system may attempt to identify a factor or factors that have a strong correlation to the user's decline in mood, and present them immediately or after a given degree of statistical confidence is achieved. In another example, the system may find that the user feels more tired on days following intense exercise. In the same example, the system may find that the user's sleep is more fragmented on nights following intense exercise. In one embodiment, if the correlation between intense exercise, fragmented sleep and lackluster energy on the following day is strong enough, and no other significant correlations are made despite adequate data sources and types, the system can suggest, but not conclude, the possibility of a causal relationship. In another embodiment, the user-specific trend can be compared to aggregate data, in order to reinforce the validity of the user-specific correlation. For example, the system may go on to find that a substantial portion of the system's population also experiences fragmented sleep on nights following intense workouts. The system is capable of considering the sequential nature of events in its analysis and observations.

General trends and correlations may be identified, based on the analysis of the user's data in relation to aggregate data. For example, the system may find that based on aggregated user data, there is an 80% chance that the user will develop type II diabetes within 12-24 months, if all variables, including diet and activity, remain constant. Or, based on aggregated research study data, people with the same gene and level of sunlight exposure have a 40% increased risk for melanoma, compared to other populations.

Noteworthy facts about a user may be identified and presented to the user, based on analysis of user data to itself, to aggregate user data or to aggregate research data. For example, by observing the user's data in relation to their own data, the system may observe that the user spent 3 hours standing yesterday, which is 30% more than average. By observing the user's data in relation to aggregate user data, the system may observe that the user is in the 95^{th} percentile for physical activity, compared to people her age. By observing the user's data in relation to aggregate research data, the system may observe that the user's vitamin D levels are 10% below levels that have been determined to be optimal.

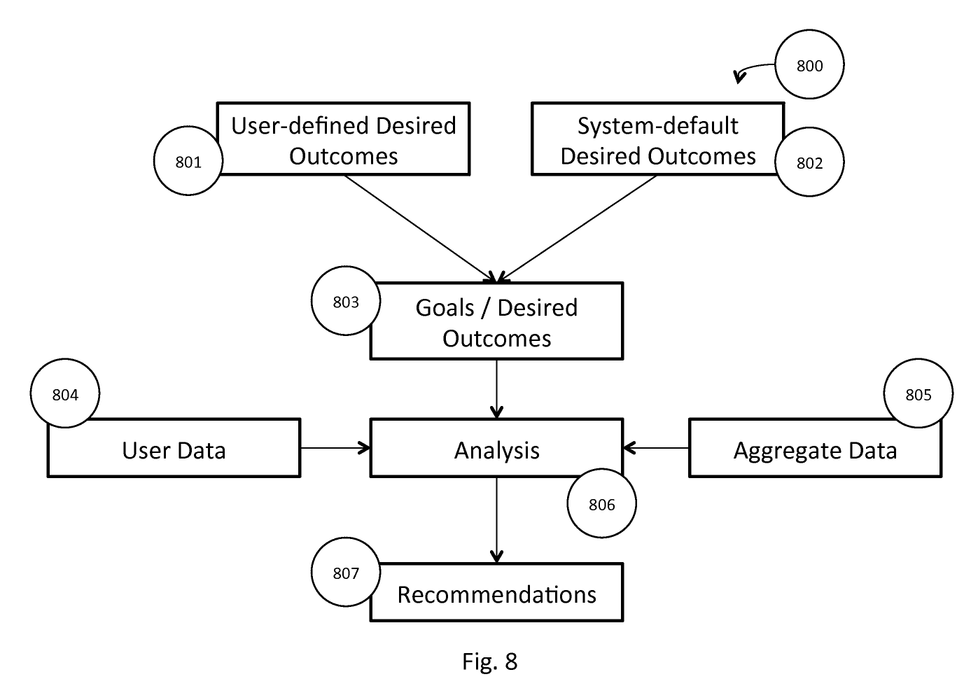

FIG. 8 illustrates a system that consists of a goal module, which defines at least one desired outcome for the given user 800. A goal, whether explicit or implicit, is used by the system to generate recommendations. Goals can be user-defined desired outcomes 801 or suggested by the system 802 to the user or a trusted third party, based on the system's analysis of aggregate data, be built into the system based on a given pre-defined set of objectives or model, or based on universal truths of living species (system-default outcomes). The goal(s) assigned to a user will be combined 803 and analyzed by the system 806 relative to user data 804 and/or aggregate data 805 in order to generate recommendations 807 (discussed in more detail below).

In one embodiment, a user can manually select one or multiple goals from a list of predefined choices. For example, the system may present categories of physical, mental, medical, activity and other goals, for the user to select from. Within each category could be subcategories, and/or specific goals that the system has determined to be feasible for the given user. Certain goals may contain variables that the user can adjust according to their preference. For example, a physical goal may be “weight loss”, and the variables may be the “number of pounds to be lost”, and “time period”. Or, a medical goal may be to reduce the user's fasting blood glucose to a 15-day average that is below 100 mg/dL. Or, an activity goal may be to “run a marathon”, with optional variables of “date of event” and “time to complete event”, or “average mile pace”.

In another embodiment, a user of the system can construct a goal. In this embodiment, the user can select from any factor(s) (types of information/data) that are being collected by the system, and set target level(s) and optionally, target achievement date(s). For example, a user may have enabled the system to collect sleep data from a bluetooth-enabled EEG. In this case, the user would be able to define a goal of improved sleep efficiency, as defined by fewer than 40 sleep arousals.

In one embodiment, the user can provide spoken or written conversational text, for the system to interpret and construct a goal from. For example, the user may speak into a device and say, “I want to be able to wear size 30 jeans by summer.” The system is capable of analyzing the text relative to the user's data, in order to determine the waist and leg circumference of size 30 jeans for a male, the date that summer begins in consideration of the user's geographic region, and if the system does not know the user's current waist circumference, can request the information from the user or use aggregated data to determine the relevant characteristics of other males who can fit into size 30 jeans (for example, height, weight, body fat percentage, body mass index, etc.).

In another embodiment, a trusted third party of the user can select a goal on behalf of the user. For example, the user's medical doctor may access the system, take note of the system's observation that the user is consuming a diet that is high in sugars, and that it is strongly correlated with the user's trends of weight gain and rise in triglycerides, then set a goal for the user to reduce their sugar intake.

Goals can be simple, such as to “be more active”, or complex and involve various factors, such as to “reduce LDL cholesterol levels”.

The system may suggest goals to the user or trusted third party, based on observations derived from the analysis of the user's data. For example, the system may observe that the user's mood has been declining precipitously over the prior four months. As a result, the system suggests to the user or trusted third party, that a general goal be set to “improve mood.” Or, in another example, the system observes that the user is 30% less physically active now than they were at the same time last year, and that the reduced activity is strongly correlated with an increase in body fat percentage that has reached unhealthy levels. The system suggests that the user set a goal of walking 10,000 steps per day, in order to return to the level that they were at one year prior. In one embodiment, the user will have the option to customize the system-generated goal suggestions. For example, the user may change the goal from 10,000 steps per day to 9,000 steps and select one of the system's dynamically generated recommendations to add 20 minutes of weight lifting. Note that the system does not require the observation module to generate observation-based goal suggestions, since the recommendation module can potentially identify the same user-specific, high-value goals. However, presenting the user with observations can provide a useful context to the user in their decision making.

Goals may also be set according to one or multiple templates or models, which consists of one or multiple goals. For example, a model may be based on an individual who the user wishes to emulate, or strive towards. The system will collect as many variables about this target individual as possible, then assign multiple goals to the user accordingly. In another embodiment, the goals may be set according to a user-selected combination of models. For example, the user may decide that they would like to strive to achieve all of Model A's physical health and a portion of Model B's lifestyle.

Goals may also be set according to generally accepted universal truths of the given living species. For example, universal truths incorporated into the system when used for humans may include the innate desire for survival, avoidance of pain, avoidance of chronic illness, desire for mobility, desire for mental and physical energy, etc. In one embodiment, goals based on universal truths are automatically assigned to users, in order to ensure that they are living in accordance with these assumptions. Note that although not all universal truths apply to all individuals in all circumstances (for example, one may not care to avoid pain in a given situation), they are generally true at most times for an overwhelming portion of the population.

The system is also capable of setting an experiment, or answering a question, as a goal. For example, a user, or the system, may wish to determine whether the user is gluten intolerant. Recommended steps for determining such will be generated by the system (discussed in more detail below).

User or third party-selected goals are set via an interface, which can include a Graphical User Interface, audio commands, images (for example, a photo of an ideal physique that the user aspires to achieve), video (for example, a video of a long jump distance that a user aspires to achieve), movement, and other factors. Interfaces can be loaded on computers, tablets, smartphones, wearable devices, biologically integrated devices, or nearly any other internet-enabled device.

In one embodiment, the system will determine whether the goals are safely and/or actually achievable by the user, before allowing them to be selected, or before suggesting them to the user. This may be accomplished through one or multiple methods, including but not limited to analysis of aggregate user or research data and rules or limitations programmed into the system.

In another embodiment, the system will allow for a user to set goals, even if unattainable, with the understanding that the user is striving towards the goal, without the requirement to achieve it.

In another embodiment, the system considers a goal to have been achieved if the user is within a pre-defined proximity of the goal. In another embodiment, the system considers the goal to have been achieved if the user meets or exceeds the pre-defined level.

In one embodiment, the system enables the user to manually prioritize their goals. For example, the goal to avoid cardiovascular disease may take precedence over the goal to be able to achieve 25 pushups in one minute. In another embodiment, the user's preferences or system's preferences, including user safety protocols, will automatically assign priorities to goals.

The system is capable of determining when a goal is in conflict with another goal(s). A goal may be in conflict with another goal when it directly or indirectly contradicts the other goal(s). For example, a direct conflict would be to gain weight while losing weight, which is physically impossible. An indirect conflict would be to lose weight while increasing caloric intake, which is possible, but only if certain steps are taken. In these cases, the system may consider goal priority and/or user and system preferences in determining which goal to accept. Or, the system may attempt to adjust the goals or associated recommendations in order to make both goals achievable. For example, in the case of the goals to lose weight and increase caloric intake, the system may propose that the user increase their physical activity, in order to make both goals achievable.

Analysis—Recommendations.

The system consists of a recommendation module, which generates one or multiple recommendations for the user to follow, including things to do or to avoid, in order to achieve one or multiple goals. Recommendations require at least one goal and the user's data to function. Recommendations may also incorporate aggregate user data, aggregate research data, system-prepared data via analysis and system-generated observations via analysis.

Recommendations may be generated after a user or trusted third party explicitly declare or select a goal, or user data automatically triggers a universal truth-based goal. For example, if the user declares the goal to “have more mental energy and be less fatigued while at work”, the system will analyze the user's data and if available, aggregate data, attempt to identify significant information that can contribute to achieving the goal, rank the recommendations, settle any conflicts, and present them. Or, if the system knows that the user is at a high genetic risk for skin cancer, and receives data that the user spent an extended period of time in the sun, it may automatically generate recommendations that will minimize factors that put the user at greater risk for skin cancer, based on the universal truth of “avoid chronic illness”.

In one embodiment, the system contains sufficient user data but does not contain aggregate user or aggregate research data. In this case, the system bases its recommendations on observations that the system generates in relation to the user's stated goal. For example, if the user's goal is to “take fewer naps”, and the system observes that the user tends to take naps within an hour of eating peanuts, and never takes naps after drinking tea, the system may generate two recommendations: “avoid consuming peanuts”, and “if you feel the urge to take a nap, immediately consume tea”.

In another embodiment, the system contains minimal user data, but an adequate amount of aggregated user and/or research data. In this case, the system bases its recommendations on correlations and trends observed from aggregate data. For example, if the user declares a goal, “minimize my risk of Parkinson's disease”, the system can generate observations from aggregated user data and research data and then make actionable recommendations based on the strongest controllable factors related to the disease. For example, it may make a general recommendation that the user “consume two to three cups of coffee per day”.

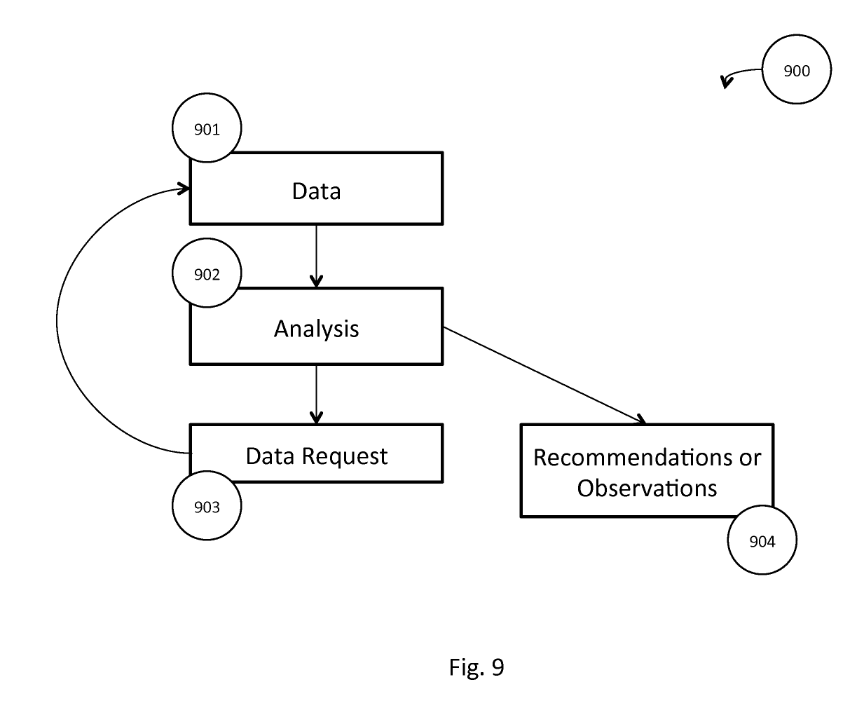

FIG. 9 illustrates an embodiment where the system asks the user to provide additional information 900. This may be in the form of a question (“how are you feeling?”, “what is your age?”), granted access to or adding another data source, performing or abstaining from one or multiple activities or environments, etc. The system makes these requests in order to improve the system's reliability, accuracy and/or effectiveness. In this case, user data 901 is analyzed 902 and found to be incomplete, inadequate for making observations or recommendations that the system is statistically confident in, requiring a limited amount of additional information to come to a firm conclusion, or a number of other reasons. In this case, the system makes a data request 903 for additional information from the user, which the user provides (note, in this case, since the request is made directly to the user, it will also involve the system's output module, discussed in detail below; for the sake of simplicity, the output module is not included in this figure). The system reanalyzes the data 902 and is able to generate new recommendations.

For example, the system may ask the user to provide a preference on a type of decision, answer a question that would contribute to the system's observations and/or recommendations (for example, “what is your age, ethnicity, etc.”, or “how are you currently feeling?”), or integrate another data source (for example, provide the system with blood test results, or access to GPS data feeds). In another example, in determining whether a user would achieve improved sleep efficiency by not consuming caffeine—a correlation that the system observed in aggregate user data—the system may recommend that the user abstain from consuming caffeine-containing substances or other stimulants for a minimum of 15 out of the following 40 days. Additionally, the system may seek out additional information 903 on its own from databases or verified websites it's connected to 901. A website can be verified by a system administrator, which will only be done when the resource abides by a strict standard of data integrity. Requests for additional data are prompted when the system is potentially capable of making a significant observation, recommendation, or improvement in the accuracy thereof, with the inclusion of the additional information.

Recommendations are made with consideration for known or potential health conditions and risks. For example, if it is known that a user has a high risk for cardiovascular disease, physical exertion-related recommendations will be limited and gradual, based on the system's analysis of aggregate user or research data. If the system contains inadequate data to know about a user's risk profile, it may not make certain recommendations, may prompt the user with questions to ascertain the user's risk profile, or may present the user with notifications that include health warnings and or waivers of consent.

In one embodiment, recommendations are broken down into steps. For example, a recommendation to achieve the goal of “lose weight” may be general, such as, “increase your physical activity.” This recommendation may then be composed of one or multiple steps, from which the user can select one or a combination. For example, steps may be “run two miles” and “bicycle 5 miles”. The user may do one, the other, or a combination, such as “run one mile” and “bicycle 2.5 miles”. Steps are to be considered as a component of recommendations, which provide instructions for undertaking the recommendation.

In certain instances, steps may be pre-established, and not be heavily reliant on user or aggregate data. In this case, process data will be relied upon. For example, if the recommendation is that the user provide their allelic variants of the ApoE gene, the steps may be composed of two options for the user to decide from: a blood test or a salivary test, with additional steps detailing the process for each option.

Recommendations and steps are dynamic, in that they can adjust based on a user's selection and/or user data. For example, if a user was instructed to walk 5,000 steps today as part of their goal that requires weight loss, but the system receives user data indicating that the user consumed an 800 calorie high-glycemic food item that was not part of their suggested or expected dietary intake, the system can dynamically update the recommendation to walk 12,000 steps for the day. If the same user happened to be a Type I Diabetic, the system may simultaneously generate a higher priority recommendation that the user inject a specific quantity of insulin upon consuming the food item.

Recommendations and steps are also dynamic in that they can be substituted for one another. For example, the system may determine that the user must be in a caloric deficit of 400 kilocalories today, in order to stay on track for their goal. The system may present the user with multiple options for achieving the 400-kilocalorie deficit, or allow the user to input their preferences for achieving the deficit. For example, the user may input into the system that they would not like to alter their diet, but would instead like to achieve the deficit via their gym's rowing machine. In this case, the system would provide the user with appropriate steps, indicating the amount of time, intensity and/or cumulative energy output that is required to achieve the goal. The system may also take the user's historical eating and activity habits into account when generating and suggesting recommendations and/or steps (sorting or ranking of its presentation). In a simplified example, if the system contains data that indicates the user frequently bicycles, yet hardly ever runs, recommendations that involve bicycling will likely outrank those that involve running.

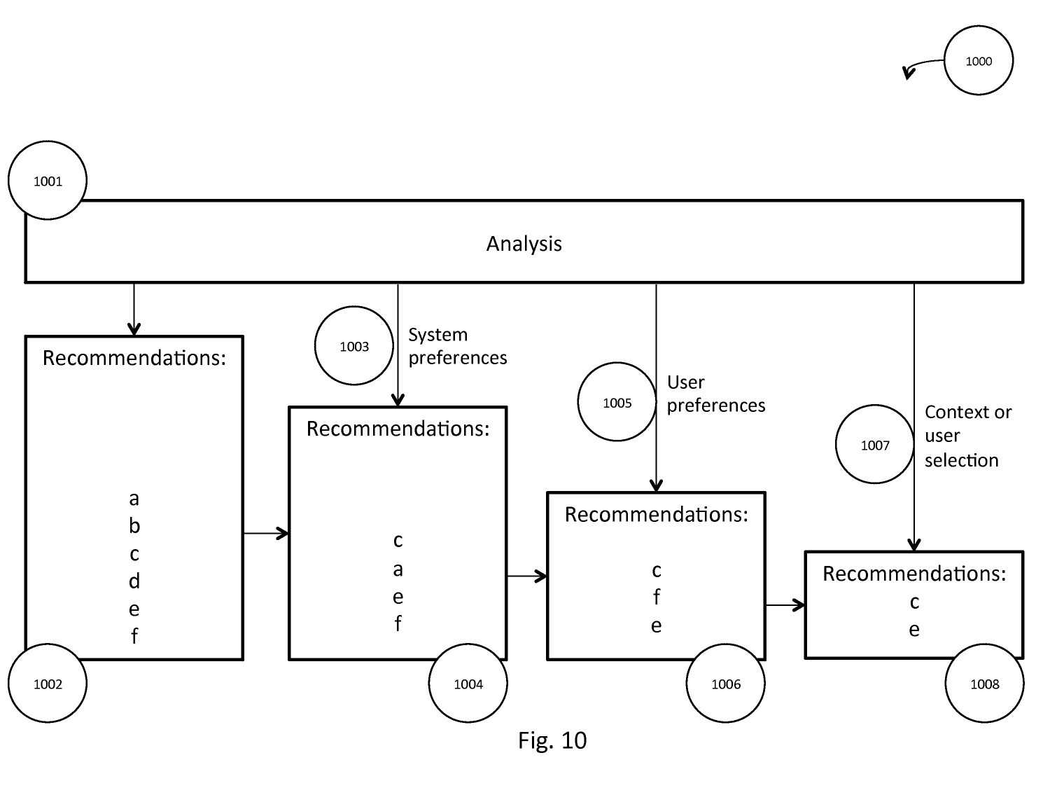

FIG. 10 illustrates a system that filters and ranks viable system-generated recommendations 1000. Initially, the analysis process 1001 generates six recommendations (a-f), ranked in order of expected effectiveness, for the user 1002. The analysis module then filters these recommendations according to system preferences 1003 (for example, do not make any recommendations that present a greater than 0.0001% chance for a fatality), and produces a further filtered and resorted list of recommendations 1004 (c, a, e, f). The analysis module then filters these recommendations according to user preferences 1005 (for example, “I prefer physical activity over adjusting my diet”), and produces a further filtered and resorted list of recommendations 1006 (c, f, e). Finally, the analysis module further filters these recommendations based on the context 1007 (for example, the device that the user is accessing the recommendations from, the user's location, time of day, etc.), and outputs recommendations 1008 (c, e).

The system is capable of determining when a recommendation is in conflict with another recommendation made to the user (or steps associated with a recommendation), the user's goal(s), the user's preference(s) and setting(s), or the user's capability(ies). For example, the system would detect a conflict if it generates a potential recommendation for the user to run three miles, when another recommendation is for the user to have a day of physical rest and recovery. Or, the system would detect a conflict if it generates a potential recommendation for the user to consume a high-glycemic banana, when a goal of the user is to reduce their blood sugar. Or, the system would detect a conflict if it generates a potential recommendation that the user consume fish for its Omega-3 fatty acid content, when the user declared that he is a vegetarian. Or, the system would detect a conflict if it generates a potential recommendation that the user spend an hour in the sun, when the user's weather forecast indicates that it's a cloudy day. In each of these cases, the system would refer to its rules and/or user preferences in determining whether it should present the user with the option to override and accept the recommendation, or, only present non-conflicting recommendations to the user. A user may be presented with the option to override and accept the recommendation if they request the ability to do so in their user settings and preferences, or possibly if the system determines that the conflict is minor. A minor conflict would be one where the impact on the achievement of goals is negligible and does not violate any fundamental preferences, user capabilities or rules of the system. The system is able to make the user aware of the potential conflict, for them to decide if they would like to accept, ignore or generate a new recommendation.

Recommendations and steps can be ranked and prioritized. A priority may be assigned to a step within a recommendation, a recommendation or step within a goal, and a recommendation or step across all goals. For example, the need for a user to consume a vital prescription drug may be prioritized above all other recommendations across all goals, when presented to the user.

Scores may be assigned to recommendations and steps. The score indicates the value that the system ascribes to the particular recommendation and/or step, and can be computed by one or multiple factors. Such factors include the system's confidence level that a recommendation or step will contribute to achieving the associated goal; if a recommendation or step will contribute to achieving more than one goal, to what degree, and the relative importance of that goal (or, user-declared priority of the goal); the system-determined likelihood that the user will perform the recommendation or goal, which can be based on the user's capabilities, history, or analysis of aggregate data; and user preferences and settings. These contributing factors' scores can be determined by the system through the analysis of the user's historical data, and/or through the analysis of the user's data in comparison to aggregate user data or aggregate research data. For example, the system may analyze aggregate user data and identify three distinct steps that other users have employed to achieve a similar goal, eliminate any steps that the user is incapable of performing, then assign the highest score to the step with the highest effectiveness, combined with having been undertaken by users who are found to be statistically most similar to the user, according to influential factors.

Recommendations may be made to a user that they alter or eliminate a goal, or the system may automatically eliminate a recommendation or goal on behalf of the user. This may occur when the system determines that the user will no longer be able to achieve the goal, the attainment of the goal is proving to be detrimental to the user or attainment of other goals, or if new information is provided to the system that makes the goal and/or associated recommendations ineffective or potentially detrimental to the user.

The system also allows for datasets or human intervention in identifying causal correlations. For example, the system may allow for the inclusion of inferences, known causal relationships, known correlations that are not causal relationships, etc. The system may also allow for technicians or researchers to review system-generated observations, and select when a correlation or trend is most likely or definitively causal or not causal. The system may leverage this data in determining whether other relationships are likely to be causal or non-causal, which observations and recommendations to output, as well as their relative ranking.

The system is capable of determining when human intervention is necessary or ideal, based on the analysis of user data and aggregate data, and can recommend such. For example, the system may determine that a user needs immediate medical care, based on dangerously high blood pressure levels.

Recommendations can relate to virtually any factor that a human can potentially exert influence on, such as intakes and consumables (food, drink and other substances), environment, lifestyle and activity, social, location, etc.

Data analysis and its resultant observations, system-generated goals, and recommendations can leverage any single or combination of established methodologies of machine learning, data mining, artificial intelligence & pattern recognition, and statistics. For example, supervised learning methods, including decision tree, ensembles, k-NN, linear regression, Naïve Bayes, neural networks, logistic regression, relevance vector machine, support vector machine and perceptron. Or, clustering, such as BIRCH, hierarchical, k-means, Expectation-maximization, DBSCAN, OPTICS and mean-shift. Or, dimensionality reduction, including factor analysis, t-SNE, PCA, NMF, CCA, ICA and LDA. Or, structured prediction, like Bayesian networks. Or, anomaly detection, including k-NN and local outlier factor. Or, neural nets, such as autoencoder, RNN, multilayer perceptron, deep learning, SOM, convolutional neural network and Restricted Boltzmann machine. The system may also utilize kernel, Markov random fields, multinomial logistic regression, fuzzy logic and probabilistic classification models.

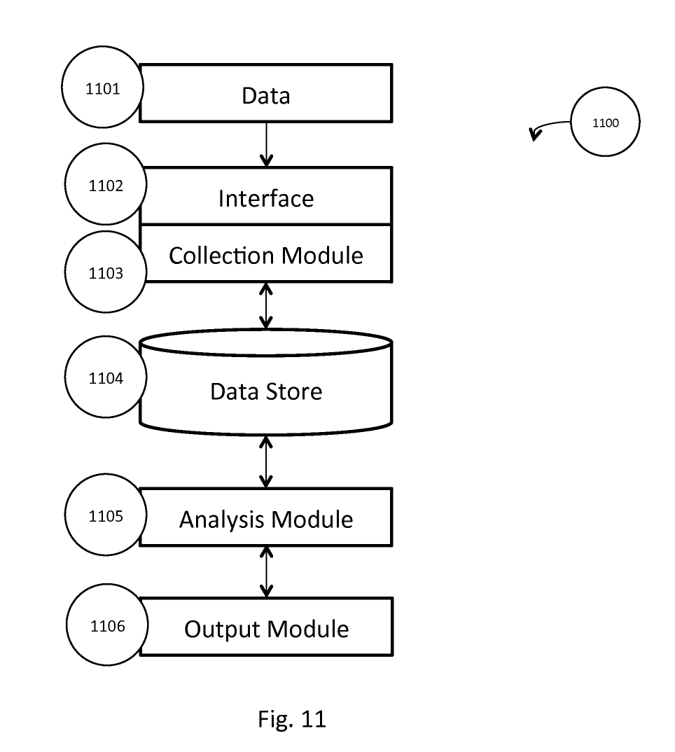

FIG. 11 illustrates how the system incorporates an output module 1100. Data 1101 is provided to the system via the system's collection interface 1102, the collection module 1103 organizes, verifies and saves that information to the appropriate part of the data store 1104, the system analyzes the data 1105, and the system outputs information 1106. The system's output module is capable of outputting raw data, prepared data, observations, goals, recommendations and their associated steps. This output can be in multiple forms, to multiple types of devices. For example, the system's output may be made accessible to third party partners via an Application Programming Interface (API). In this case, information can be outputted from the system directly to third party applications and devices, such as smartphones and their applications, biometric watches, medical computer servers, etc. Additionally, it is possible for specific recommendations or steps to be outputted to a device that is biologically integrated into a user, for automatic or manual processes to be initiated. For example, the device may be instructed to automatically track the user's blood glucose levels for the next 48 hours, in 60-second intervals. Or, the system may output a recommendation to a user's connected watch that they immediately add 8 international units of human growth hormone (HGH) to their blood stream, which the user accepts and a biologically integrated device releases the HGH. Note that output can be for any portion or combination of information, and would most likely be limited to device and situation-specific contexts, to minimize on data transfer requirements.

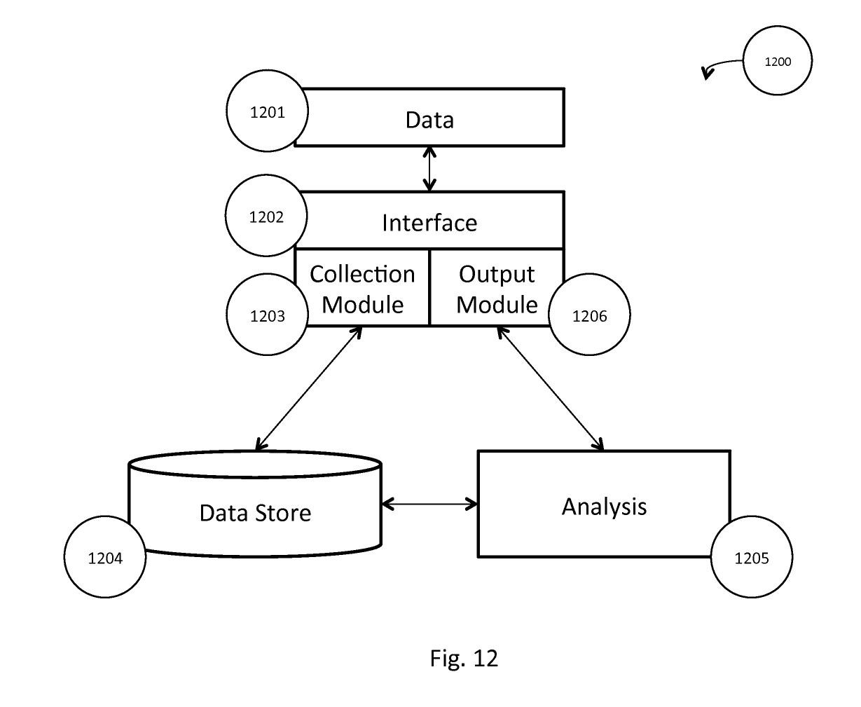

FIG. 12 illustrates an embodiment where the collection (input) and output are connected to the same interface 1200. In this instance, devices would be able to provide data 1201 to be collected 1203 and stored 1204 via the interface 1202, have that data analyzed by the system 1205, then see the resulting information 1201 (aggregate data, observations, recommendations, etc.), due to the output module's 1206 connection to the interface 1202.

The output module may provide information to the user and/or trusted third parties. For example, through preferences and settings, a user may grant full system access to their medical doctor, who among other abilities is capable of seeing the system's observations and recommendations. The doctor can use this information to add, adjust or remove goals; request that the user provide additional information to the system; and select which observations and recommendations the user can see.

The system may have its own user interface(s) for presenting system output, and may or may not be incorporated into the same system interface(s) that connect to the collection module. This user experience would consist of a graphical user interface, the ability to add data, set preferences and settings, select desired outcomes, and experience the systems output.

The system may output general and specific insights for the user to read as a guidebook, rather than as a dynamic experience. For example, the system may come to firm conclusions about a user, including food sensitivities, caffeine tolerance and ideal dosage,

The system may also have it's own software development kit (SDK), for third parties to be able to develop software, in which case all outputted information can potentially remain within the system.

The system requires a computer. A computer is ideally composed of a processor, system memory and a system bus.

The system's computing environment includes one or more client(s) and server(s), each of which can be hardware and/or software (e.g., computing devices, processes, threads). Data can be transmitted and stored between and on the client(s) and server(s).

The system can operate in a networked environment, in which devices, computers and data stores are connected to each other through a network interface.

What has been described above includes examples of the innovation. It is not possible to describe all conceivable combinations of components or methodologies, but one of ordinary skill in the art may recognize that many other combinations or permutations of the subject innovation are feasible. Accordingly, the claimed subject matter is intended to embrace all such alterations, modifications, and variations that fall within the spirit and scope of the appended claims.

There are multiple ways of implementing the present innovation, e.g., an API, tool kit, operating system, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

In addition, while a particular feature of the subject innovation may have been disclosed with respect to only one of multiple implementations, such feature may be combined with one or more other features of the other implementations as may be desired and advantageous for any given or particular application.

1. A system that makes actionable recommendations for the accomplishment of health or lifestyle outcomes, or outcomes influenced by health or lifestyle factors, consisting of:
an interface module for connection to one or multiple data sources;
a collection module, for receipt and organization of data;
a data store, for the storage of data;
an analytical module, for the analysis of data;
and, an output module, for the output of system information.

2. The system of claim (1), wherein said collection module collects data from end-users' or third parties' devices connected to said interface, about factors that can be indicators of health, lifestyle or related outcomes.

3. The system of claim (1), wherein said collection module collects data from end-users' or third parties' devices connected to said interface, about factors that can influence health, lifestyle or related outcomes.

4. The system of claim (1), wherein said collection module collects data from research studies transferred via said interface, about factors that relate to health, lifestyle or related outcomes.

5. The system of claim (1), wherein said data includes an end-user's health, lifestyle or related outcomes that they wish to achieve.

6. The system of claim (1), wherein said collection module collects data that indicate system default desired outcomes assigned to the end-user.

7. The system of claim (1), wherein an analytical module generates recommendations to an end-user for working towards achieving an outcome.

8. The system of claim (1) where an analytical module uses supervised learning computational methods.

9. The system of claim (1) where an analytical module uses clustering computational methods.

10. The system of claim (1) where an analytical module uses structured prediction computational methods.

11. The system of claim (1) where an analytical module uses anomaly detection computational methods.

12. The system of claim (1) where an analytical module uses neural net computational methods.

13. The system of claim (7) where recommendations are based on analysis of end-user data in relation to the desired outcome.

14. The system of claim (7) where recommendations are based on analysis of aggregate data in relation to the desired outcome.

15. The system of claim (7) where recommendations are based on analysis of end-user data and aggregate data in relation to the desired outcome.

16. The system of claim (7) where one or more recommendations can be dynamically added, altered or removed as new information is collected by the system.

17. The system of claim (1) where the analytical module can request additional data from the end-user in order to be able to make a recommendation or to improve the accuracy of a recommendation.

18. The system of claim (1) where the analytical module can request additional data from connected databases and verified websites, in order to make a recommendation or to improve the accuracy of a recommendation.

19. The system of claim (1) wherein the output module, comprises:
an output module that outputs system-collected data;
system-generated recommendations;
and, system-generated data requests to the end-user, system administrator or a database that it is connected to;
in the form of data, audio, video, image, requests, processes, sequences, or commands.

20. A computer-implemented method that facilitates evaluating collected health, lifestyle or environmental data in order to generate one or more reliable recommendations in order for an individual to achieve a given outcome, comprising:
gathering data related to health, lifestyle or factors that may influence health or lifestyle from end-users, their devices or verified third parties;
gathering data related to health and factors that may influence health or lifestyle from research studies;
gathering any desired outcomes from an end-user;
gathering system default desired outcomes from a system administrator;
organizing all collected data into semantic, relational or object-oriented databases, in order to facilitate statistical analysis of the end-user's data;
analyzing the organized data in order to generate at least one recommendation for the end-user to come closer to achieving a desired outcome;
enabling the user to interact with dynamic data, desired outcomes, observations or recommendations through an internet-based data feed to the system's servers or a cloud.
